(19) United States
(12) Patent Application Publication
(10) Pub. No.: US 2015/0037836 A1
(43) Pub. Date: Feb. 5, 2015

(54) TEMPERATURE CONTROLLED DISSECTION AND OBSERVATION STAGE

(71) Applicants: Brandon Morris, Shepherdsville, KY (US); William D. Ehringer, Charlestown, IN (US); Joshua Howard, Louisville, KY (US); DeVonnah Woodruff, Kalamazoo, IN (US); Dhruvinkumar Patel, Louisville, KY (US); Kristyn Smith, Louisville, KY (US)

(72) Inventors: Brandon Morris, Shepherdsville, KY (US); William D. Ehringer, Charlestown, IN (US); Joshua Howard, Louisville, KY (US); DeVonnah Woodruff, Kalamazoo, IN (US); Dhruvinkumar Patel, Louisville, KY (US); Kristyn Smith, Louisville, KY (US)

(21) Appl. No.: 14/448,264

(22) Filed: Jul. 31, 2014

Related U.S. Application Data
(60) Provisional application No. 61/860,556, filed on Jul. 31, 2013.

(51) Int. Cl. G02B 21/28; G02B 21/26; G02B 21/30; G01N 1/28

(52) U.S. Cl. CPC G02B 21/28; G01N 1/286; G02B 21/26; G02B 21/30; G01N 2001/2873
USPC 435/40.5; 359/395

(57) ABSTRACT

A temperature controlled tissue dissection and observation stage comprises a central working area and a first temperature controlled station positioned within the central working area. The first temperature controlled station comprises a first temperature controlling element configured to adjust the temperature of the first temperature controlled station. The stage further comprises a user input device in communication with the first temperature controlling element. In one embodiment, the stage comprises four temperature controlled stations. Three of these stations are designed to house petri dishes filled with solutions required for tissue restoration and reconstruction surgeries, and the fourth station is configured to function as a flat cutting surface for the user. In one embodiment, thermostatic control over the system is achieved through the integration of thermoelectric coolers, a microcontroller, and feedback temperature sensors.

### PRIORITY

This application claims priority to U.S. Provisional Patent Application Ser. No. 61/860,556, filed Jul. 31, 2013, entitled “Temperature Controlled Dissection and Observation Stage,” the disclosure of which is incorporated by reference herein.

### BACKGROUND

Embodiments of a dissection and observation stage that can be used to control tissue temperature during observation and manipulation under a microscope are disclosed herein. Some embodiments are configured to allow tissue to be maintained within a fixed temperature range during ex vivo processing, which helps sustain tissue viability and function.

The need for a temperature-controlled platform arises from the challenges faced during current methods of ex vivo tissue dissection. Several temperature-related events can occur during dissection and observation, which can lead to decreased tissue viability and function. Firstly, tissues undergoing surgical excision are often held at room temperature under ischemic conditions where there is a loss of oxygen and nutrient flow to the tissue. Because the tissue is still metabolically active there is constant loss of intracellular ATP as well as accumulation of metabolic by-products. One method of decreasing intracellular ATP loss and metabolic by-products is to cool the tissue. Another method utilized to minimize ATP reduction, as well as minimize increases in metabolic by-products, involves hydrating the tissue by immersion in an appropriate holding solution. Typically, the temperature of the holding or wetting solution is kept at as close as possible to the current temperature of the tissue. Third, the tissue should not undergo significant change in temperature to avoid thermal shock. Tissues warmed under the microscope or rapidly cooled via ice solution can experience thermal shock. Tissues experiencing thermal shock will experience a number of potentially adverse intracellular events as result. Potential adverse events induced by thermal shock include the release of heat-shock proteins and induced oxidative stress, which contribute to tissue damage. Embodiments described herein address these three major issues that could impact the viability and function of said dissected tissues. Moreover, embodiments may decrease the variability associated with day-to-day tissue dissection by controlling the tissue temperature during processing and observation.

One example of how embodiments described herein can be useful is in the field of hair transplantation. During a hair transplant procedure, a section of scalp tissue is removed and then separated into follicular graft units, usually consisting of one to four follicles by a nurse or technician under a dissection microscope. Isolation of the follicular graft units is a lengthy and dexterously challenging process. This procedure often takes 2-3 hours to complete depending on the number of grafts being transplanted. During the dissection of the scalp tissue into follicular units, the tissue experiences several significant changes in temperature. First, the tissue is placed in a holding solution on ice, dropping the temperature of the tissue to about 6-9° C. Second, when the tissue is placed under the microscope and slivered (the harvested scalp is cut into small strips), the tissue temperature rises from about 6-9° C. to about 20-25° C. Third, the isolated slivers are put back into a cold holding solution decreasing tissue temperature from about 20-25° C. to about 6-9° C. As each sliver is placed under the microscope for follicular unit isolation, the temperature is again changed from about 6-9° C. to about 20-25° C. Finally, the isolated follicular units are placed back into a cold holding solution, resulting in another temperature change from about 20-25° C. to about 6-9° C. These dramatic changes in tissue temperature can result in thermal shock to the tissue, ultimately affecting the viability and function of the hair follicles, and potentially the outcome of the transplant procedure.

The cells of tissues exposed to thermal shock can undergo a myriad of intracellular changes that affect cell function. For example, heating or cooling of tissues outside of their normal metabolic temperature will activate the heat-shock response, resulting in the accumulation of heat shock proteins. These heat shock proteins assist in the correct folding of the three-dimensional structure of the proteins. However, in ex vivo tissues experiencing ischemia, the ability of the cell to produce the protective heat shock proteins is decreased resulting in significant accumulation of misfolded, non-functional proteins. Another effect of temperature change on the cells of tissues is membrane bilayer related. During the heating or cooling process, the phospholipids of membrane bilayers can become more or less permeable to ions respectively, which in turn affects membrane potential, ATP synthesis, intracellular signaling, and other ion-dependent events. Rapid changes in temperature of tissues can also induce apoptosis or cellular retraction, via actin-dependent reorganization. Collectively, these temperature-dependent intracellular events can significantly influence tissue viability and function.

Disclosed embodiments are configured so that the isolated tissue can remain at a near constant temperature during the entire dissection and/or observation process. Unlike previous attempts that have utilized mechanical refrigeration to keep tissue chilled, disclosed embodiments combine temperature regulation of the tissue with the ability to examine the tissue under an observation device, such as a stereo microscope or an upright microscope with epi-illumination. Embodiments disclosed herein comprise temperature controlled stations that can hold a petri dish, such as a 100 mm petri dish or other types of dishes for pre- and post-processing of tissues. Additionally, in some embodiments, a centrally located working area allows stereomicroscopes or upright microscopes to be used to observe the tissue for careful dissection.

While a variety of tissue dissection and observation stages have been made and used, it is believed that no one prior to the inventors has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective view of an exemplary temperature controlled dissection and observation stage

FIG. 2 depicts a top plan view of the stage of FIG. 1;

FIG. 3 depicts a top plan view of the stage of FIG. 1 with the top panels removed to reveal internal piping and instrumentation inside the stage;

FIG. 4 depicts a cross-sectional, front view of an exemplary temperature controlled station assembly incorporated within the stage of FIG. 1;

FIGS. 5A-5C depict an exemplary circuit diagram of the stage of FIG. 1; and

FIG. 6 depicts a flow diagram for exemplary software of the stage of FIG. 1;

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain embodiments should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

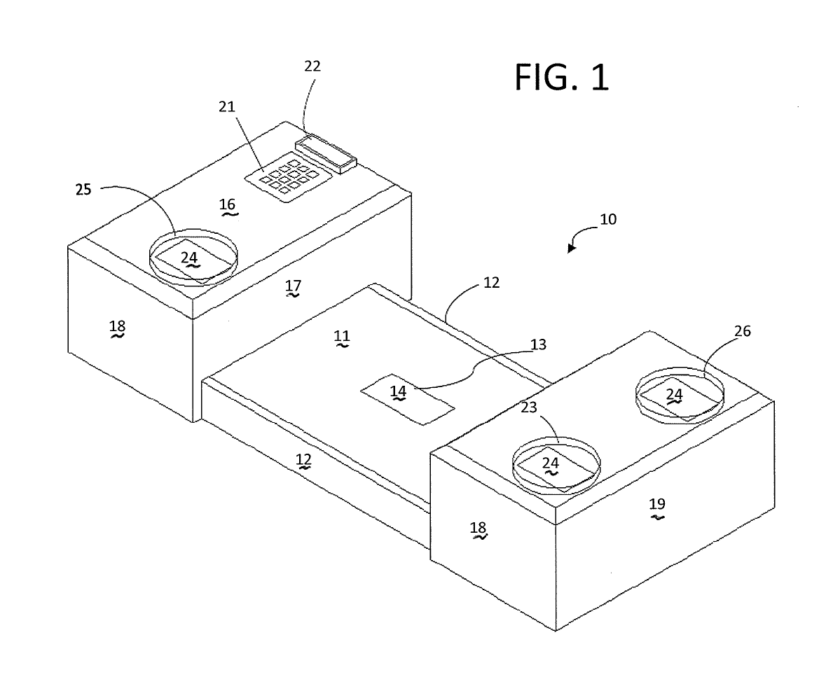

FIGS. 1-6 illustrate an embodiment of a temperature controlled tissue dissection and observation stage configured for use in tissue dissection. The illustrated embodiment allows the tissue dissection procedure to be performed in a temperature controlled environment.

The temperature controlled dissection and observation stage 10 shown in FIGS. 1-3 may comprise parts preferably manufactured using a biocompatible acetal polymer compound known by the trademarked name of Delrin. In some embodiments all structural components comprising the physical support structure of the stage 10 are preferably manufactured using Delrin or other biocompatible material. As used herein, the term “structural components” of stage 10 refers to components 11, 12, 15, 16, 17, 18, 19, and 20. The structural components can also be manufactured using other biocompatible materials such as, nylon, polypropylene, etc. The individual parts may be fastened together using stainless steel screws, adhesives, plastic welding or any other suitable fastening device or method.

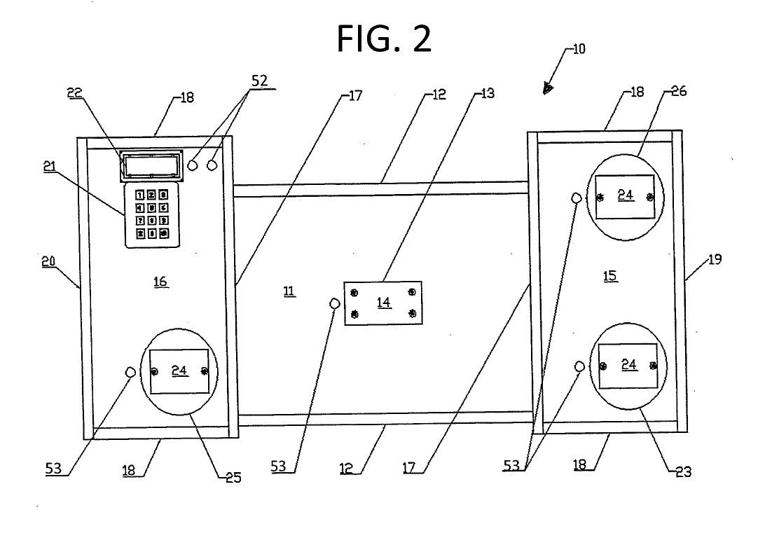

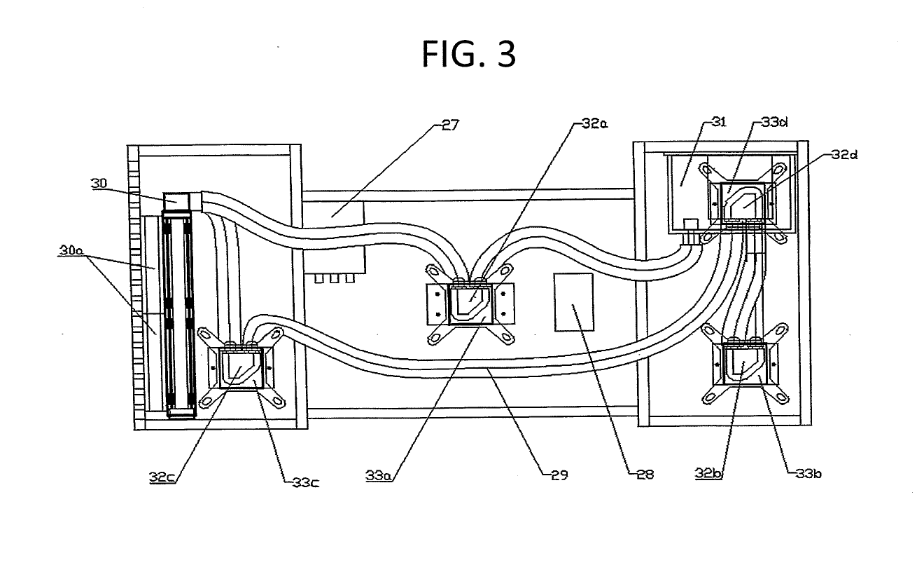

The physical structure of the stage 10 is displayed in FIGS. 1 and 2, while FIG. 3 details the internal piping and instrumentation. By way of example, stage 10 may comprise dimensions including a length of 78.1 cm, a width of 35 cm, and a height of 16.1 cm. These values are exemplary and are capable of being altered depending on the intended functional environment of the device.

Stage 10 comprises a primary, flat, central working area 11 configured to be used for the dissection of tissue. In the illustrated embodiment, central working area 11 is configured to provide enough free working space for the average technician to rest their forearms comfortably on the surface. Additionally, in this embodiment, central working area 11 comprises a low profile that is configured to allow stage 10 to be used in conjunction with existing stereo dissection microscope technology. In this embodiment, central working area 11 houses the first temperature controlled station 13 and provides a working space that is both ergonomic and easily integrates with existing stereo or upright microscopes using epi-illumination. The illustrated configuration provides a free range of motion over the central portion of stage 10, allowing existing microscopes to interface directly over temperature controlled station 13. This area, particularly the temperature controlled station 13, is configured to be used while the tissue is under the microscope.

By way of example only, central working area 11 may comprise dimensions chosen to provide the above-described functionality, such as a length of 38.1 cm, and a width of 38.1 cm. Central working area 11 may also be about 1.3 cm thick, and, as shown, is supported in the front and back by the structural sides 12. In the illustrated embodiment, supports 12 raise the top of the central working area 11 to a height suitable to facilitate use, such as about 5.1 cm. These values are exemplary and are capable of being altered depending on the intended functional environment for the device.

As shown in FIGS. 1 and 2, the first temperature controlled station 13 is located at the center of the central working area 11. This station 13 is configured to control the temperature of donor tissue during the dissection procedure. As shown, station 13 is positioned to allow a dissection microscope objective to be placed directly above station 13. The working surface of station 13 is a stainless steel plate 14 which provides a thermally conductive biocompatible surface capable of transferring heat to internal components. In other embodiments, the plate 14 may be composed of another hospital grade material suitable to provide an adequate cutting surface and a thermally conductive biocompatible surface capable of transferring heat to internal components. In this embodiment, the plate 14 is sized to perform optimally given the size and capabilities of the internal temperature controlling equipment. By way of example only, dissection plate 14 may comprise a length of 10 cm, a width of 5.0 cm, and a thickness of 1.125 nm. To accommodate dissection plate 14 and provide for direct contact with underlying equipment, an inlay exists in the center of central working area 11 with dimensions matching that of the plate. By way of example only, the inlay may comprise a depth of about 1.125 mm. Additionally, working area 11 also comprises an opening configured to house the underlying heat dissipation equipment. By way of example only, the opening may be positioned in the center of the inlay and comprise a substantially square opening measuring 5.0 cm by 5.0 cm. The dimensions described herein are exemplary and are capable of being altered depending on the intended functional environment for the device.

As shown in FIGS. 1 and 2, stage 10 also comprises two raised working areas 15 and 16. These raised working areas are configured to provide tissue storage pre and post dissection. They are raised above the central stage to encourage tissue separation and a neat work flow. In the illustrated embodiment, central working area 11 and raised working areas 15 and 16 are separated by two side structure supports 17. These supports 17 create an enclosure around working area 11 and provide the internal structural support for both raised working areas 15 and 16. By way of example, structural supports 17 can measure 12.7 mm in width, 35.0 cm in length, and 14.5 cm in height. The internal portion of these supports 17 can be hollow in order to allow piping and wires to extend between the central working area 11 and the raised working areas 15 and 16. These values are exemplary and are capable of being altered depending on the intended functional environment for the device.

Along with side supports 17, in this embodiment, raised working areas 15 and 16 connect to structural sides 18, 19, and 20. Side 18 refers to the front and back structural sides surrounding raised working areas 15 and 16, as shown in FIG. 1. By way of example only, sides 18 may have a length of 17.5 cm, width of 12.7 mm, and height of 14.5 cm. In the illustrated embodiment, side 19 refers to the right structural component of the overall stage 10 and completes the enclosure around working area 15. Side 20 creates the left structural component of the overall stage 10 and completes the enclosure around working area 16. In this embodiment, structural sides 19 and 20 are identical with the only difference being that side 20 is perforated to allow airflow inside stage 10. By way of example, the dimensions for sides 19 and 20 can be 12.7 mm in width, 35.0 cm in length, and they may have a height of 14.5 cm. These values are exemplary and are capable of being altered depending on the intended functional environment for the device.

As shown in FIGS. 1 and 2, raised working areas 15 and 16 are located on the right and left of stage 10, respectively. These raised working areas 15 and 16 are configured in this embodiment to house the remaining three temperature controlled stations as well as the user input device 21 and the feedback device 22.

As shown, the user input device 21 in the illustrated embodiment is a twelve button, membrane, tactile keypad containing the numbers 0-9 for entering temperature values. In this embodiment, user input device 21 also contains a * (star), which can be used to toggle between Fahrenheit and Celsius temperature scales and a # (pound) button, which can be used as a confirmation button. Other input methods and devices suitable to allow a user to input the required information, such as the desired temperature, may be used, including but not limited to a slider, knob, or up/down arrows.

In the embodiment shown in FIGS. 1 and 2, feedback device 22 comprises a liquid crystal display. In this embodiment, feedback device 22 is configured to display keypad selections, target temperature, ready indications, and current temperatures. Feedback device 22 may also comprise two different color LED indicators which can be used to designate when the device is adjusting the temperature of the stations, and when it has reached the target temperature. Other methods and devices suitable to provide desired feedback to the user may be used, including but not limited to seven segment LED displays, VFD's, and Nixie Tubes.

As shown in FIGS. 1 and 2, the second temperature controlled station 23 is located in the front half of raised working area 15. Temperature controlled station 23 may be used to control the temperature of unprocessed donor tissue prior to dissection. Typically the tissue is held in a petri dish filled with solution prior to dissection. In this embodiment, temperature controlled station 23 is contained in a well configured to house a standard 100 mm diameter petri dish, although other types and sizes of dishes may be used. The size and shape of temperature controlled station 23 and the associated well may be modified compared to the illustrated embodiment in order to accommodate other types and sizes of dishes. The portion of the well where the temperature is controlled is sealed using a thermally conductive stainless steel plate 24. The plate 24 can be made of any material that is both thermally conductive and biocompatible. By way of example, plate 24 may comprise dimensions of 75 mm in length, 50 mm in width, and 1.125 mm in height. These values are exemplary and are capable of being altered depending on the intended functional environment for the device.

In the illustrated embodiment, the third temperature controlled station 25 and the fourth temperature controlled station 26 share a substantially identical design with the second temperature controlled station 23. As shown, the third temperature controlled station 25 is located on the front half of the raised working area 16. This station 25 may be used as a temperature controlled storage area for separated tissue prepared for further dissection or transplantation. In this embodiment, the fourth temperature controlled station 26 is located on the back half of the raised working area 15 and may be used to hold a petri dish containing a tissue holding solution. When the petri dish containing the tissue holding solution is positioned on station 26, the tissue holding solution will be temperature controlled and can be used to re-wet or hydrate the tissue during dissection. Typically, solution is added to the tissue throughout the dissection process to prevent the tissue from dehydrating. Holding this solution at the same temperature as the rest of the process eliminates temperature shock when the solution is applied to the tissue.

FIG. 3 depicts an internal diagram of stage 10, displaying the inner tubing and instrumentation. Components found in FIG. 3 include the major parts to the water loop as well as the power supply 27 and printed circuit board 28. Connection tubing 29, which may comprise antimicrobial material, is also visible in this figure.

In the illustrated embodiment, power is provided to stage 10 in the form of a commercial, enclosed, single output power supply 27. In this embodiment, power supply 27 provides a 12 volt, 320 watt output while relying on a standard 120 volt input from a typical wall outlet. As shown, power supply 27 is mounted under the central working area 11.

In the illustrated embodiment, each temperature controlled station 13, 23, 25, and 26 is controlled using a temperature controlling element comprising a thermoelectric cooler 33a, 33b, 33c, and 33d. Although thermoelectric coolers are preferred due to their ability to accurately control the amount of heat transferred by the element due to their electrical nature, other types of temperature controlling elements may be used in other embodiments, including but not limited to refrigeration elements, or other suitable elements configured to provide adequate temperature control. The thermoelectric coolers 33a, 33b, 33c, and 33d, also known as Peltiers, are composed of a ceramic casing surrounding two conductors with different Seebeck coefficients. The thermoelectric coolers 33a, 33b, 33c, and 33d comprise square ceramic plates on the top and bottom of the conductors to provide a hard and thermally conductive surface. These square plates are then sealed together using silicone caulk on the sides. The casing also has two wires protruding from one of its sides. When a voltage is applied across these wires, the thermoelectric coolers produce a temperature gradient between the top and bottom surface. This results in a heat pump, which pulls heat from the top of the thermoelectric cooler 33a, 33b, 33c, and 33d (the cold side) and expels it out the bottom (the hot side). Due to the electrical nature of the thermoelectric coolers 33a, 33b, 33c, and 33d, it is possible to control the amount of heat transferred between the two sides by manipulating the power input to the cooler 33a, 33b, 33c, and 33d.

The thermoelectric coolers 33a, 33b, 33c, and 33d require some type of heat dissipation system in order to provide a cooling function, as is well known in the art. In the illustrated embodiment of stage 10, the heat dissipation system comprises a closed circuit water loop. The components of the water loop in the illustrated embodiment are a radiator 30, two fans, such as 120 mm fans 30a, a submersible pump and reservoir (housed within reservoir case 31), and four water block assemblies 32a, 32b, 32c, and 32d. Generally speaking, radiators, such as radiator 30, are heat exchangers, and radiator 30 in this embodiment is configured to transfer heat from the water loop to its copper fins. In this embodiment, two fans 30a are securely fastened to the side of radiator 30 in order to provide heat dissipation from the copper fins to the ambient. Fans 30a may be fastened to radiator 30 using any suitable fastener or fastening method, including but not limited to conventional fasteners, an adhesive, and combinations thereof. The pump is configured to provide the necessary driving force to constantly move water through the loop. A reservoir can be used to provide extra fluid to the water system, allowing the system to operate at a temperature closer to ambient. In this embodiment, the pump is submersible and is located inside the reservoir container 31 to conserve space. In the illustrated embodiment, the four water block assemblies 32a, 32b, 32c, and 32d interface directly with the thermoelectric coolers at each of the four temperature controlled stations 13, 23, 25, and 26. In this embodiment, the bottom, hot side, of the thermoelectric cooler is secured in direct contact with the copper portion of the water block. This direct contact allows heat to dissipate from the hot side of the thermoelectric cooler to the copper surface of the water block. Compression fittings, elbow joints, and antimicrobial tubing 29 can all be used in conjunction to connect the water system components together in one distinct, bacteria free, closed loop. The fluid used in this embodiment is distilled water; however, other bacteria free coolants would be acceptable.

In the illustrated embodiment, the water loop functions as an entire unit, dependent on each component to dissipate heat. In this embodiment, when heat is generated from the bottom surface of a respective thermoelectric cooler 33a, 33b, 33c, and 33d, it transfers to the copper plate on the respective water block assembly 32a, 32b, 32c, and 32d. Fluid from the water loop then travels through internal channels inside the copper portion of the respective water block assembly 32a, 32b, 32c, and 32d, transferring heat from the copper into the water stream. The heat is then transported via the water, by means of the pump, to the radiator 30, where it is transferred to the radiator's copper fins. In this embodiment, once the heat is displaced on the copper fins, the two fans, such as 120 mm fans 30a, disperse the heat to the ambient air through the perforations in structural side 20.

As shown in FIG. 2, the water loop comprises a radiator 30. As previously discussed, radiator 30 transfers heat between the water system and the ambient air through the use of fans 30a and copper fins. In this embodiment, water is transferred to and from the radiator by means of two G ¼″ standard ports. Other types of heat exchangers suitable to adjust the temperature of the water utilized by stage 10 may be used. In the illustrated embodiment, the water loop further comprises reservoir container 31. The reservoir container 31 houses the pump and the reservoir. In this embodiment, the pump creates the driving force behind the water system, while the reservoir provides a space for additional water volume in the system. In alternate embodiments, the heat dissipation system may be different and, as a result, in those embodiments the reservoir container and/or pump may not be necessary. By way of example only, other embodiments may utilize a heat dissipation system that utilizes air as the heat dissipation fluid instead of water. Those embodiments may utilize one or more fans to provide the driving force for the air instead of the pump described in the illustrated embodiment.

The water loop in the illustrated embodiment also comprises a plurality of water block assemblies 32a, 32b, 32c, and 32d, each of which interface directly with a respective temperature controlled station 13, 23, 25, and 26. In this embodiment, each water block assembly 32a, 32b, 32c, and 32d includes a copper block heat exchanger, a grooved housing, a support brace, and at least one conventional fastener or fastening method, including but not limited to screws. Four individual assemblies 32a, 32b, 32c, and 32d are mounted inside stage 10. As shown, an assembly 32a, 32b, 32c, and 32d can be found centered under each temperature controlled station 13, 23, 25, and 26. When mounted, the copper block extends inside the opening located under the stainless steel covering plates 14 and 24. In this embodiment, the block does not occupy the entire opening, thus leaving a small cavity between the copper block and the stainless steel covering plates. This cavity is where the respective thermoelectric coolers 33a, 33b, 33c, and 33d reside.

The thermoelectric coolers 33a, 33b, 33c, and 33d provide the heat pump for the illustrated embodiment. This embodiment includes four thermoelectric coolers 33a, 33b, 33c, and 33d, with one being located at each station. As previously mentioned, the thermoelectric coolers 33a, 33b, 33c, and 33d are positioned between the copper block of a respective water block assembly 32a, 32b, 32c, and 32d and the corresponding stainless steel covering plates 14 and 24 at each station 13, 23, 25, and 26.

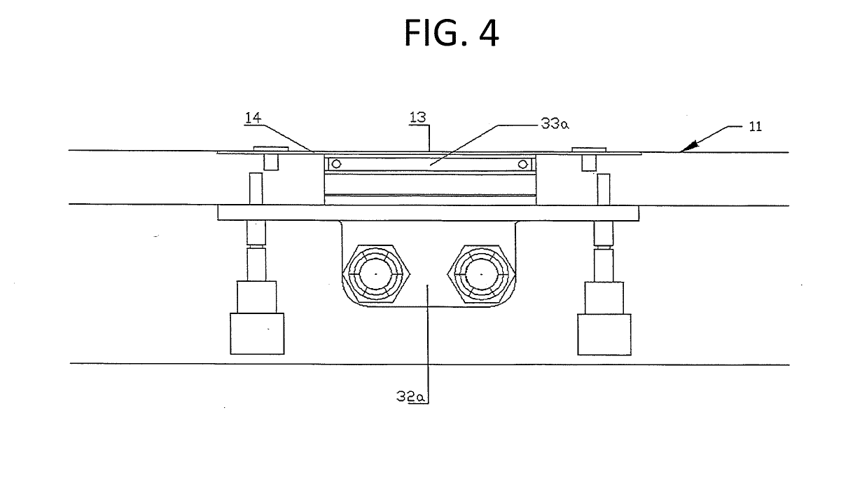

FIG. 4 depicts the orientation of water block assembly 32a, the thermoelectric cooler 33a, and the stainless steel covering plate 14. In this embodiment, all three of these components are held in contact with each other due to being fastened to the central working area 11 by conventional fasteners, such as screws. They are secured in order to achieve the highest rate of thermal transfer possible. While the cross sectional view shown in this figure is of the first temperature controlled station 13, the principle orientations of the components remain the same for the other three stations 23, 25, and 26. Other orientations of like or similar components may also be used, provided they allow adequate thermal transfer between the components.

In an alternate embodiment, the temperature controlling element may be configured to heat the temperature controlled station and any tissue samples or solution contained therein instead of cooling the temperature controlled station as in the particular embodiment described herein. By way of example only, it will be appreciated by those skilled in the art that the thermoelectric coolers 33a, 33b, 33c and 33d described herein could be used to heat each respective temperature controlled station 13, 23, 25, and 26 by reversing the polarity of the power supplied to the thermoelectric coolers. Reversing the polarity of the power supplied to the thermoelectric cooler would result in heat being pulled from the bottom of the thermoelectric cooler (resulting in the bottom becoming the cold side) and being expelled out the top (resulting in the top becoming the hot side).

In yet another alternate embodiment, a microcontroller and related components may be configured to allow the temperature controlling elements to alternate between heating and cooling depending on the relationship between the current temperature of each temperature controlled station and the desired target temperature. In other words, if the current temperature of a particular temperature controlled station is above the target temperature, then the microcontroller could be configured to cause the temperature controlling element to cool the temperature controlled station until its current temperature reaches the target temperature. Alternatively, if the current temperature of a particular temperature controlled station is below the target temperature, then the microcontroller could be configured to cause the temperature controlling element to heat the temperature controlled station until its current temperature reaches the target temperature. This selective functionality may be implemented automatically by the microcontroller and an internal switch or an input from the user may be required via the input device, an external switch, or some other means to alternate the stage between cooling and heating functions.

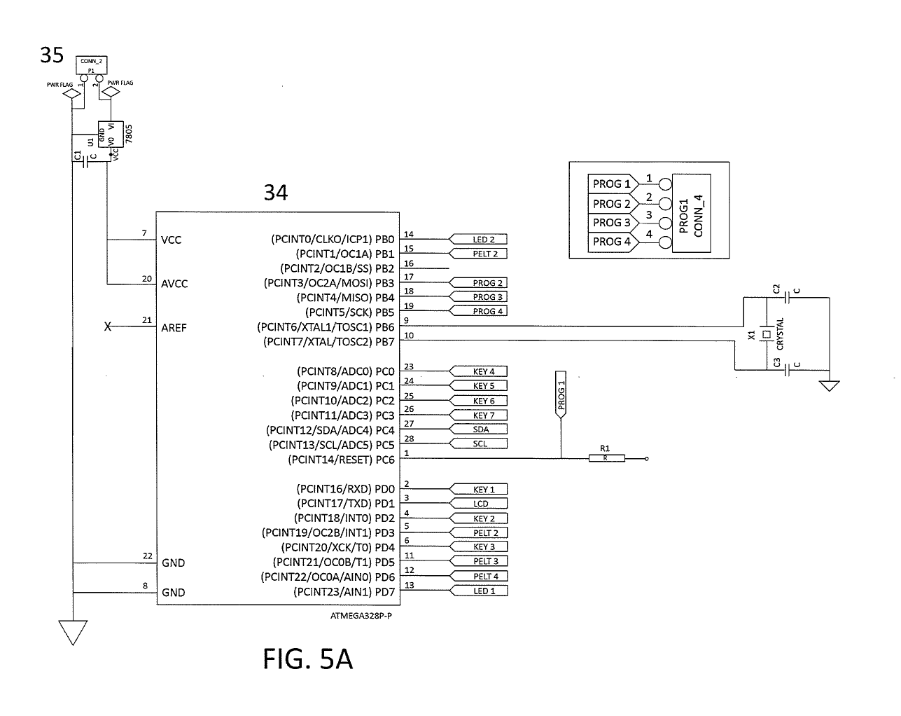

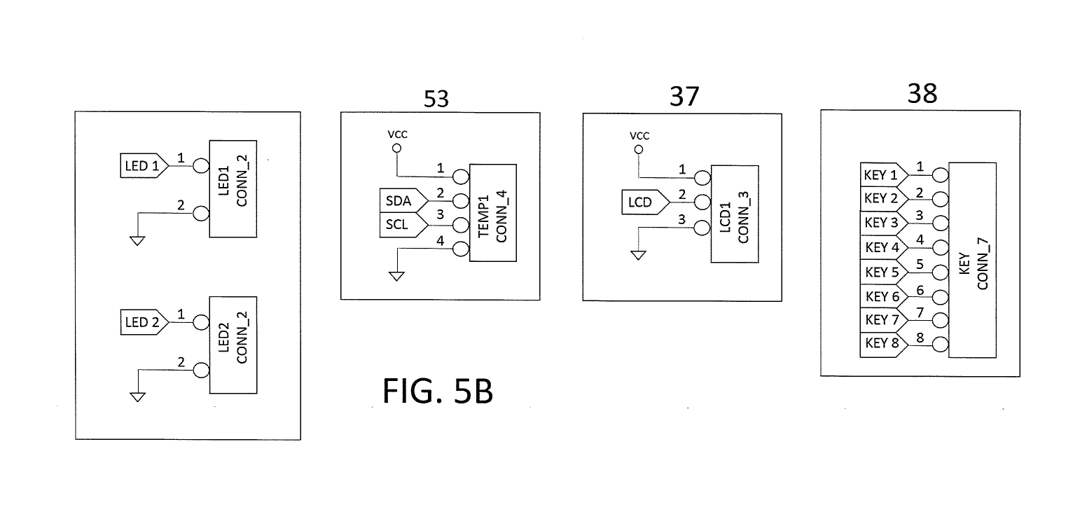

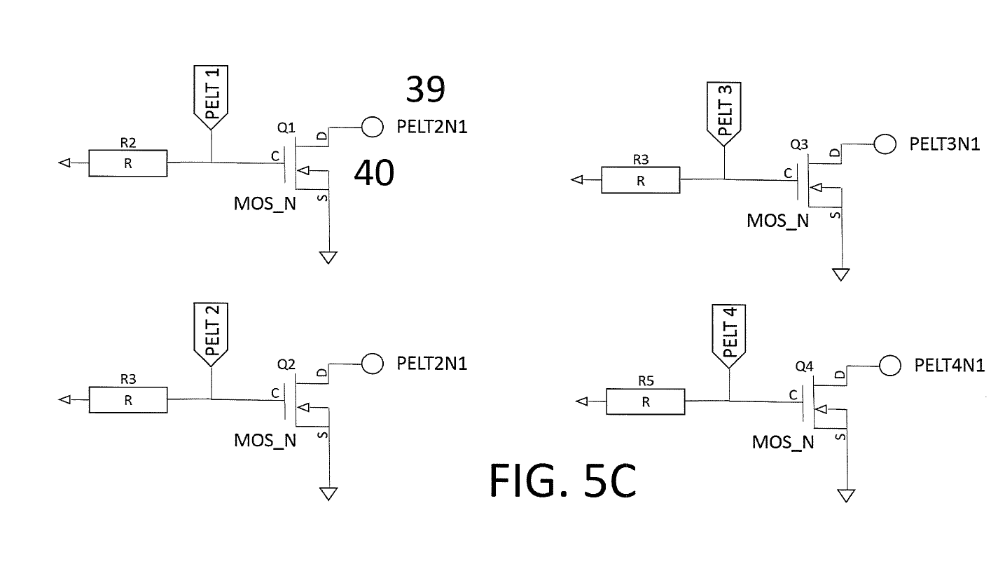

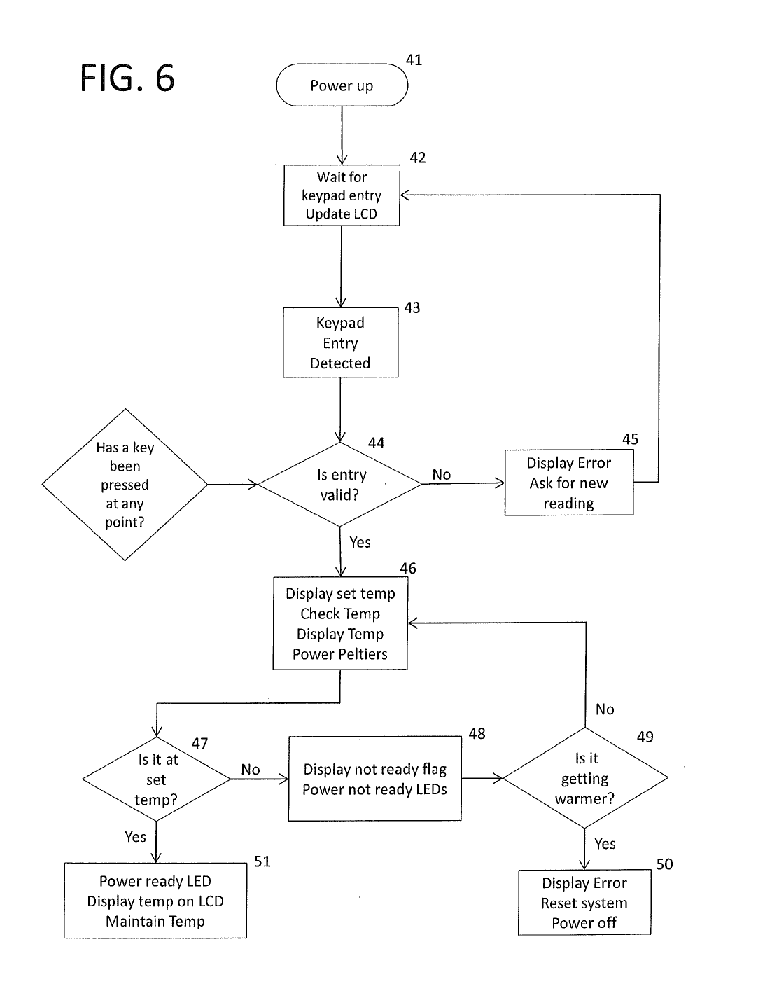

FIGS. 5A-5C depict a circuit diagram of the electrical system. Because stage 10 is configured to provide a constant temperature during the entire dissection and/or observation process, it is beneficial to accurately control the temperature at each station 13, 23, 25, and 26. In this embodiment, the temperature at each temperature controlled station 13, 23, 25, and 26 is controlled using a thermoelectric cooler 33a, 33b, 33c, and 33d and infrared temperature sensors 53. As shown, the four stations 13, 23, 25, and 26 share a user input device 21 (e.g. a keypad), a feedback device 22 (e.g. a liquid crystal display and indicator LEDs), and a microcontroller 34. The microcontroller 34 uses a temperature control algorithm for each thermoelectric cooler 33a, 33b, 33c, and 33d to achieve the desired temperature during operation. The function of this control algorithm is detailed later in block diagram form in FIG. 6.

In this embodiment, each thermoelectric cooler 33a, 33b, 33c, and 33d provides the heat pump for each corresponding station 13, 23, 25, and 26, cooling everything in direct contact with the top surface. The user input device 21 provides the user with the ability to choose the operating temperature at which they desire to hold the stations 13, 23, 25, and 26, and ultimately the tissue. One or more indicators, such as LED indicators 52 or other individual LED indicators associated with each respective station 13, 23, 25 and 26, can show when the stations 13, 23, 25, and 26 need to be cooled down or heated up to reach the desired temperature. The feedback device 22 can display information such as the temperature selected, as well as the current temperature of each station. The feedback device 22 can also provide instructions to the user regarding changing the operating temperature or other helpful information.

Control over the temperature controlling system at each station 13, 23, 25, and 26, and the stage 10 as a whole, is handled by the microcontroller 34 which is integrated onto the printed circuit board 28 in the illustrated embodiment. As shown, the printed circuit board 28 is located under central working area 11′, although other suitable placements may be used in other embodiments. FIGS. 5A-5C depict a circuit diagram that shows connections between the microcontroller 34 and other electrical equipment, including but not limited to the power cable 35, infrared temperature sensor communication cables connected to infrared temperature sensors 53, feedback device communication cables 37, input device input and communication cables 38, and thermoelectric cooler power cables 39.

In the illustrated embodiment, power is provided to the printed circuit board 28 by the enclosed single output power supply 27. The remaining electronic equipment, except for the thermoelectric coolers 33a, 33b, 33c, and 33d, is powered via the microcontroller 34 and has an operating voltage of about 5 volts. In this embodiment, power to the thermoelectric coolers 33a, 33b, 33c, and 33d is provided directly by the 12 volt power supply 27, and is regulated via the microcontroller 34. The microcontroller 34 regulates the power provided to the thermoelectric cooler power cables 39 via N-Channel MOSFETs 40. Specifically, the control of the thermoelectric coolers 33a, 33b, 33c, and 33d can be achieved via microcontroller 34 receiving readings from the temperature sensors and controlling the amount of power provided through an N-Channel MOSFET 40 for each thermoelectric cooler 33a, 33b, 33c, and 33d. MOSFETs 40 allow the microcontroller to vary the power to the thermoelectric coolers 33a, 33b, 33c, and 33d to effectively control the temperatures of each station 13, 23, 25, and 26. The microcontroller 34 can vary the power to each thermoelectric cooler 33a, 33b, 33c, and 33d and thus the amount of heat each thermoelectric cooler 33a, 33b, 33c, and 33d moves is based on a control algorithm programmed into the microcontroller's nonvolatile memory. Those skilled in the art should recognize that other suitable electronic components can be used for power control such as TRIACs, relays, etc.

Infrared temperature sensors 53 can be used in the thermostatic control process due to their ability to provide feedback in the form of temperature measurements at each station 13, 23, 25, and 26. These measurements can be used in the control algorithm to update the temperatures over time. This allows the microcontroller to vary power to each station 13, 23, 25, and 26 individually in the illustrated embodiment to better maintain a constant temperature throughout the process. In one embodiment, actual thermostatic function of the device begins when the user selects a valid input temperature and inputs it via input device 21. In some embodiments, the valid input temperature is below ambient, which requires stage 10 to cool the temperature controlled stations 13, 23, 25, and 26 down to the input or target temperature. In other embodiments, the valid input temperature is above ambient, which requires stage 10 to heat the temperature controlled stations 13, 23, 25, and 26 up to the input or target temperature. In some embodiments, valid temperature ranges for the device can be between 0° C. and 37° C., and preferably between 0° C. and 20° C. in order to prevent material from freezing or overheating; however, temperatures outside of this range are capable of being achieved. In this embodiment, once a valid temperature is chosen using the input device 21, the feedback device 22 updates in real time indicating the stage 10 has received the user's direction and is proceeding to change all four stations 13, 23, 25, and 26 to the selected temperature.

Turning to FIG. 6, an example of the temperature control process for stage 10 as executed by microcontroller 34 is detailed. In the illustrated embodiment, when power is initially established the feedback device 22 acknowledges that stage 10 is powered on (as shown by Power-Up Stage 41) and awaiting an input from the input device 21 (as shown by Awaiting Input Stage 42). When an input from the input device 21 is detected (as shown by Input Detection Stage 43) the microcontroller 34 checks to ensure that the entry is valid by comparing it to a predetermined range of valid temperature values (as shown by Validity Check Stage 44). Valid temperature values for the device in the current embodiment are between 0° C. and 20° C. In one embodiment, the range of valid temperature values is a factory setting and is unable to be altered by the user. In other embodiments, the range of valid temperature values is programmable and may be altered by the user, such as by inputting the desired range via the input device 21 in response to an appropriate prompt or prompts on the feedback device 22. If the temperature value received is not a valid value (as shown by Display Error Stage 45), the feedback device 22 displays an error message indicating that a new temperature input is necessary and the process returns to Awaiting Input Stage 42. If the temperature value received is valid, the feedback device 22 displays the selected temperature and a message informing the user that the stage 10 requires some time in order to achieve this set temperature (as shown by Display Set Temp Stage 46). In this embodiment, a red colored LED light is also powered on to indicate that the device is not ready for use. The microcontroller 34 will then proceed to check the temperature of each temperature controlled station 13, 23, 25, and 26 via the infrared temperature sensors 53 (as shown by Temp Check Stage 47). If the microcontroller 34 determines that the temperature at a specific station 13, 23, 25, and 26 is warmer than the valid target temperature, then the microcontroller 34 will provide power to the thermoelectric cooler 33a, 33b, 33c, and 33d at that respective station 13, 23, 25, and 26 in an attempt to cool the station 13, 23, 25, and 26 (as shown by Not Ready Stage 48). Alternatively, if the microcontroller 34 determines that the temperature of a specific station 13, 23, 25, and 26 is colder than the valid target temperature, then the microcontroller 34 will disengage power to the thermoelectric cooler 33a, 33b, 33c, and 33d at that station 13, 23, 25, and 26, and attempt to warm the station 13, 23, 25, and 26 by means of ambient heating or, in some embodiments, the microcontroller 34 may reverse the polarity of the power provided to the thermoelectric cooler 33a, 33b, 33c, and 33d in an attempt to warm the respective station 13, 23, 25, and 26. The microcontroller 34 will continue to monitor the temperature at each station 13, 23, 25, and 26 and if it detects a predetermined rise in temperature (as shown by Getting Warmer Stage 49) during a time that one of the thermoelectric coolers 33a, 33b, 33c, and 33d is engaged with the intention of cooling, the feedback device 22 will show an error message before powering down the stage 10 so that the user or a technician can check to ensure the temperature controlling system is functional and the thermoelectric coolers 33a, 33b, 33c, and 33d are snug against their corresponding water block assemblies 32a, 32b, 32c, and 32d (as shown by Reset and Power-Off Stage 50). In this embodiment, if the microcontroller 34 determines that a particular station 13, 23, 25, and 26 has achieved the valid target temperature during Temp Check Stage 47, the red colored LED light will power off and a green colored LED light will power on, indicating the device is ready for use (as shown by Display and Maintain Stage 51). The feedback device 22 will also display a ready message before returning to a screen showing the temperature of each station. The process returns to the Temp Check Stage 47, thereby allowing the stage 10 to maintain the temperature of every station at the respective target temperature until power is no longer provided to the device or the user enters a different valid input. Those skilled in the art should understand that other suitable heating and cooling methods and mechanisms, LED light colors and mechanisms, and methods and mechanisms to monitor and control the temperature may be used in other embodiments.

In an alternate embodiment, the temperature control process described above may be changed in order to allow the stage to heat the temperature controlled stations to a target temperature above ambient. For example, Power-Up Stage 41, Awaiting Input Stage 42, Input Detection stage 43, Validity Check Stage 44, Display Error Stage 45, and Display Set Temp Stage 46 may be carried out as described above. The microcontroller will then proceed to check the temperature of each temperature controlled station via the infrared temperature sensors. If the microcontroller determines that the temperature at a specific station is cooler than the valid target temperature, then the microcontroller will reverse the polarity of the power, and provide power to the thermoelectric cooler at that respective station. Alternatively, if the microcontroller determines that the temperature of a specific station is higher than the valid target temperature, then the microcontroller will disengage power to the thermoelectric cooler at that station and attempt to cool the station by means of ambient cooling or, in some embodiments, the microcontroller will provide power to the respective thermoelectric cooler without reversing the polarity in an attempt to cool the respective station. The microcontroller will continue to monitor the temperature at each station and if it detects a predetermined drop in temperature during a time that one of the thermoelectric coolers is engaged to provide heat to the respective station, the feedback device will show an error message before powering down the stage so that the user or a technician can check to ensure the temperature controlling system is functional. In this embodiment, if the microcontroller determines that a particular station has achieved the valid target temperature, the red colored LED light will power off and a green colored LED light will power on, indicating the device is ready for use. The feedback device will also display a ready message before returning to a screen showing the temperature of each station. The process continues to check the current temperatures of each station in order to maintain the temperature of every station at the target temperature until power is no longer provided to the device or the user enters a different valid input.

Having shown and described various embodiments, further adaptation of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1. A dissection and observation stage comprising:
a central working area;
a first temperature controlled station positioned within the central working area, wherein the first temperature controlled station comprises a first temperature controlling element configured to adjust the temperature of the first temperature controlled station; and
a user input device, wherein the user input device is in communication with the first temperature controlling element.

2. A dissection and observation stage as in claim 1, wherein the first temperature controlling element comprises a thermoelectric cooler.

3. A dissection and observation stage as in claim 1, further comprising a second temperature controlled station, wherein the second temperature controlled station comprises a second temperature controlling element configured to adjust the temperature of the second temperature controlled station, wherein the user input device is in communication with the second temperature controlling element.

4. A dissection and observation stage as in claim 3, further comprising a third temperature controlled station, wherein the third temperature controlled station comprises a third temperature controlling element configured to adjust the temperature of the third temperature controlled station, wherein the user input device is in communication with the third temperature controlling element.

5. A dissection and observation stage as in either claim 4, further comprising a fourth temperature controlled station, wherein the fourth temperature controlled station comprises a fourth temperature controlling element configured to adjust the temperature of the fourth temperature controlled station, wherein the user input device is in communication with the fourth temperature controlling element.

6. A dissection and observation stage as in claim 5, wherein the first temperature controlling element, the second temperature controlling element, the third temperature controlling element, and the fourth temperature controlling element are each controlled independently.

7. A dissection and observation stage as in claim 5, wherein the first temperature controlling element, the second temperature controlling element, the third temperature controlling element, and the fourth temperature controlling element each comprise a thermoelectric cooler.

8. A dissection and observation stage as in claim 5, wherein at least one of the first temperature controlled station, the second temperature controlled station, the third temperature controlled station, or the fourth temperature controlled station comprises a well configured to receive a petri dish.

9. A dissection and observation stage as in claim 5, wherein the first temperature controlled station, the second temperature controlled station, the third temperature controlled station and the fourth temperature controlled station each comprise a respective plate comprising thermally conductive, biocompatible material.

10. A dissection and observation stage as in claim 1, further comprising a first raised working area.

11. A dissection and observation stage as in claim 10, further comprising a second raised working area, wherein the central working area is positioned between the first raised working area and the second raised working area.

12. A dissection and observation stage as in claim 1, wherein the central working area comprises a profile configured to fit underneath a dissection microscope.

13. A dissection and observation stage as in claim 1, further comprising a feedback device in communication with at least one of the first temperature controlled station and the user input device.

14. A dissection and observation stage as in claim 1, further comprising a heat dissipation system, wherein at least a portion of the heat dissipation system is in contact with the first temperature controlling element.

15. A dissection and observation stage as in claim 14, wherein the heat dissipation system comprises at least one water block assembly associated with the first temperature controlling element.

16. A dissection and observation stage as in claim 14, wherein the heat dissipation system comprises a radiator, at least one fan adjacent to the radiator, at least one water block assembly, a pump, and a reservoir.

17. A dissection and observation stage as in claim 1, wherein the first temperature controlling element is configured to cool the first temperature controlled station.

18. A dissection and observation stage as in claim 1, wherein the first temperature controlling element is configured to heat the first temperature controlled station.

19. A dissection and observation stage comprising:
a central working area;
a first raised working area and a second raised working area, wherein the central working area is positioned between the first raised working area and the second raised working area;
a user input device;
a first temperature controlled station positioned within the central working area, wherein the temperature controlled station comprises a first temperature controlling element configured to adjust the temperature of the first temperature controlled station, wherein the user input device is in communication with the first temperature controlling element;
a second temperature controlled station, wherein the second temperature controlled station comprises a second temperature controlling element configured to adjust the temperature of the second temperature controlled station, wherein the user input device is in communication with the second temperature controlling element;
a third temperature controlled station, wherein the third temperature controlled station comprises a third temperature controlling element configured to adjust the temperature of the third temperature controlled station, wherein the user input device is in communication with the third temperature controlling element;
a fourth temperature controlled station, wherein the fourth temperature controlled station comprises a fourth temperature controlling element configured to adjust the temperature of the fourth temperature controlled station, wherein the user input device is in communication with the fourth temperature controlling element; and
a heat dissipation system, wherein at least a portion of the heat dissipation system is in contact with the first temperature controlling element;
wherein the second temperature controlled station and the fourth temperature controlled station are positioned within the second raised working area, and
wherein the user input device and the third temperature controlled station are positioned within the first raised working area.

20. A method of dissecting and observing tissue comprising the following steps:
(a) providing a dissection and observation stage comprising
a microcontroller,
a first temperature controlled station comprising a first temperature controlling element in communication with the microcontroller and a first plate adjacent to the first temperature controlling element,
a second temperature controlled station comprising a second temperature controlling element in communication with the microcontroller and a second plate adjacent to the second temperature controlling element,
a third temperature controlled station comprising a third temperature controlling element in communication with the microcontroller and a third plate adjacent to the third temperature controlling element, and
a fourth temperature controlled station comprising a fourth temperature controlling element in communication with the microcontroller and a fourth plate adjacent to the fourth temperature controlling element;
(b) storing a quantity of pre-dissection tissue in a container positioned on the second plate;
(c) obtaining a tissue sample from the quantity of pre-dissection tissue;
(d) transferring the tissue sample to the first plate;
(e) dissecting the tissue sample on the first plate to create a post-dissection tissue sample;
(f) transferring the post-dissection tissue sample to a container positioned on the third plate;
(g) storing a quantity of holding solution in a container positioned on the fourth plate; and
(h) controlling the first temperature controlling element, the second temperature controlling element, the third temperature controlling element, and the fourth temperature controlling element with the microcontroller such that the quantity of pre-dissection tissue, the tissue sample, the post-dissection sample, and the quantity of holding solution are maintained at substantially the same temperature as each other during steps (b) through (g).
